(19) United States
(12) Patent Application Publication
(10) Pub. No.: US 2009/0183074 A1
(43) Pub. Date: Jul. 16, 2009

(54) Sound Display Devices

(75) Inventors: Sian Lindley, Cambridge (GB); Lorna Brown, Cambridge (GB); Abigail Durrant, London (GB); David Frohlich, Elstead (GB); Gerard Oleksik, Bradwell (GB); Dominic Robson, London (GB); Francis Rumsey, Guildford (GB); Abigail Sellen, Cambridge (GB); John Williamson, Glasgow (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/972,326

(22) Filed: Jan. 10, 2008

(51) Int. Cl. G06F 3/048; G06F 3/16

(52) U.S. Cl. 715/716; 715/727

(57) ABSTRACT

The disclosure relates to presenting sound. In some embodiments, this is a visual presentation. One embodiment provides a presentation of sound built over time, which may be displayed in layers similar to strata in a sedimentary rock formation. In another embodiment, the visual presentation is an animated presentation which reflects a characteristic, for example the volume, of the sound at that instant.

### BACKGROUND

Representation of sound is often carried out using an oscilloscope capable of displaying a sound wave or by keeping a record of a parameter associated with the sound, such as a measure of decibels. Other prior art sound systems are capable of representing sounds which the sound system is playing in the form of moving shapes such as wave patterns, spirals and the like shown on a display integral to the sound system. However, such displays are not as versatile or as attractive as may be desired.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The disclosure relates to presentations of sound. One embodiment provides a presentation of sound built over time, which may be displayed in layers similar to strata in a sedimentary rock formation. In another embodiment, the visual presentation is a presentation which reflects a characteristic, for example the volume, of the sound at that instant.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a sound display device;

FIG. 2 is a schematic diagram of the processing circuitry of the sound display device of FIG. 1;

FIG. 3 is a flow diagram of a method for using the apparatus of FIG. 1;

FIG. 4 is a schematic diagram of the display of a sound display device;

FIG. 5 is a schematic diagram of the display of a sound display device;

FIG. 6 is a schematic diagram of a sound display device;

FIG. 7 is a schematic diagram of the processing circuitry of the sound display device of FIG. 6; and

FIG. 8 is a flow diagram of a method for using the device of FIG. 6; Like reference numerals are used to designate like parts in the accompanying drawings.

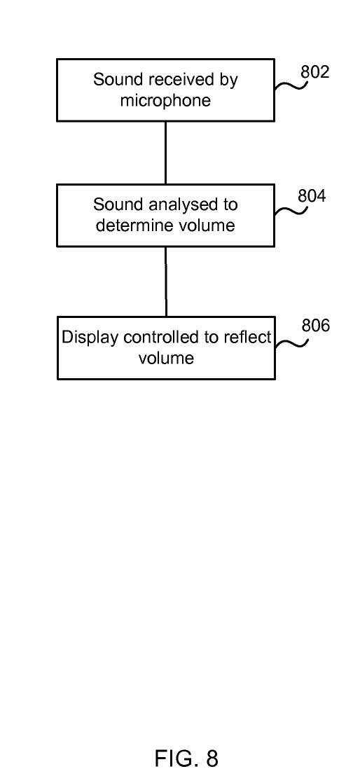

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

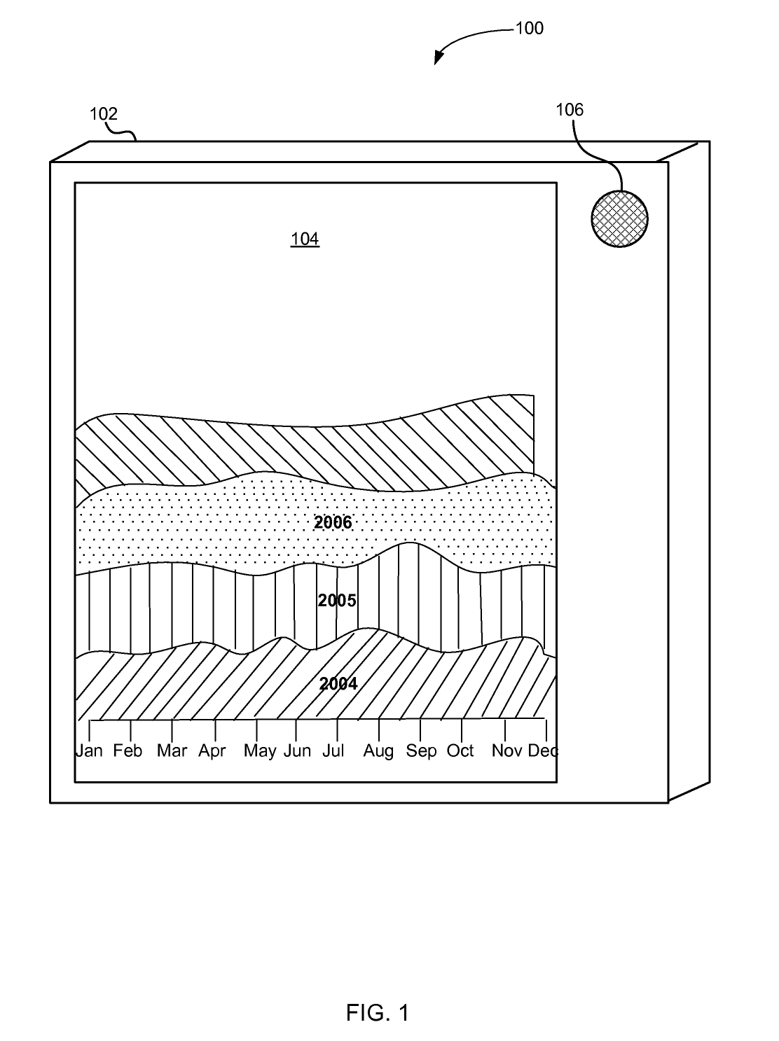

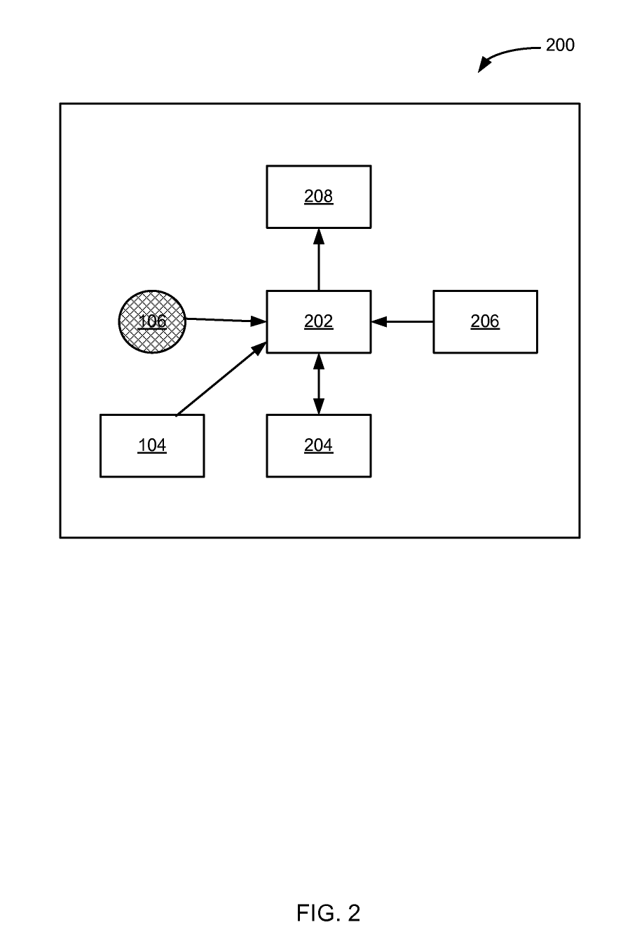

FIG. 1 shows an embodiment of a sound display device 100 comprising a housing 102, in which is housed a display panel, in this case a touch sensitive Liquid Crystal Display (LCD) panel 104 and a microphone/speaker 106. The housing 102 contains processing circuitry 200 as is shown in FIG. 2.

The processing circuitry 200 comprises a microprocessor 202, a memory 204, a clock/calendar 206 and a display driver 208. The microprocessor 202 is arranged to accept inputs from the touch sensitive display panel 104, the microphone/speaker 106 and the clock/calendar 206 and is arranged to store data in and retrieve data from the memory 204. The microprocessor 202 is also arranged to control the display on the display panel 104 using the display driver 208.

In this embodiment, the touch sensitive display panel 104 comprises a surface layer which stores electrical charge and electrical circuits capable of measuring capacitance at each corner, as is known to the person skilled in the art. When a user touches the touch sensitive display panel 104, some of the charge from the layer is transferred to the user, which results in a decrease of charge on the touch sensitive display panel 104. This decrease is measured in the circuits and these measurements are input to the microprocessor 202. The microprocessor 202 uses the differences in charge as measured at each corner to determine where the finger (or other object) touched the touch sensitive display panel 104. Of course, other types of touch sensitive devices could be utilized in other embodiments.

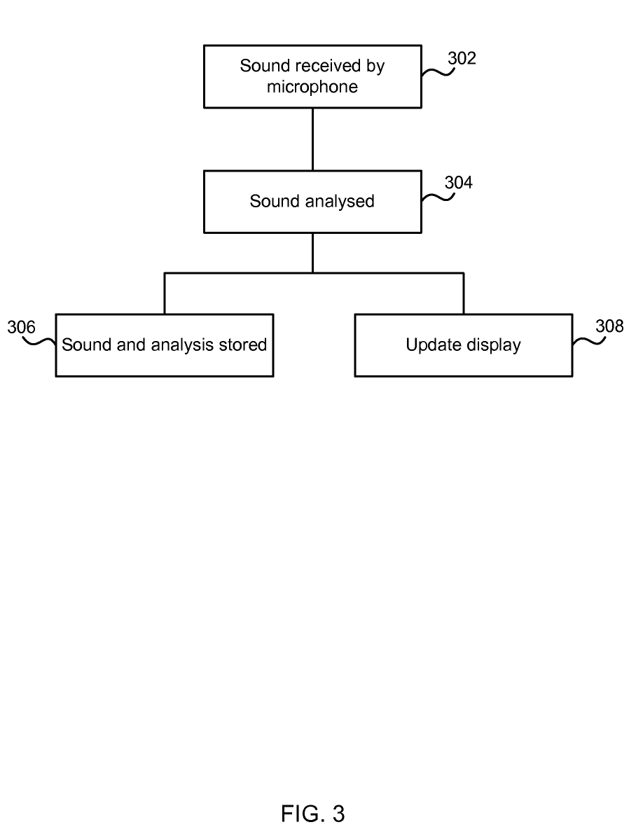

Use of the sound display means 100 is now described with reference to the flow chart of FIG. 3.

Sound which is received by the microphone/speaker 106 (block 302) is analyzed by the microprocessor 202 in order to determine the volume in decibels and also to categorize the noise (block 304). The noise may for example be categorized as ‘conversation’, ‘music/TV’ or ‘background noise’ using known sound recognition techniques. As will be familiar to the person skilled in the art, there are known methods of sound recognition, for example, using probabilistic sound models or recognition of features of an audio signal (which can be used with statistical classifiers to recognize and characterize sound). Such systems may for example be able to tell music from conversation depending on characteristics of the audio signal. The sound, its volume in decibels and its category are stored in the memory 204 along with the present date and time (block 306) and the display panel 104 is controlled by the display driver 206 to display a representation of the sound, as is now described (block 308). In other embodiments, the sound may be analyzed to determine further, or alternative characteristics.

As is shown in FIG. 1, the display panel 104 is arranged to display a series of ‘strata’ (so called herein due to their visual similarity with sedimentary strata in rocks), each of which is associated with a calendar year. The strata are visually distinct from one another and are of variable height. The height of each stratum is associated with the volume of noise received by the microphone/speaker 106 at the associated time. In this example, the volume is smoothed over a 24-hour period to provide a smoothly varying height.

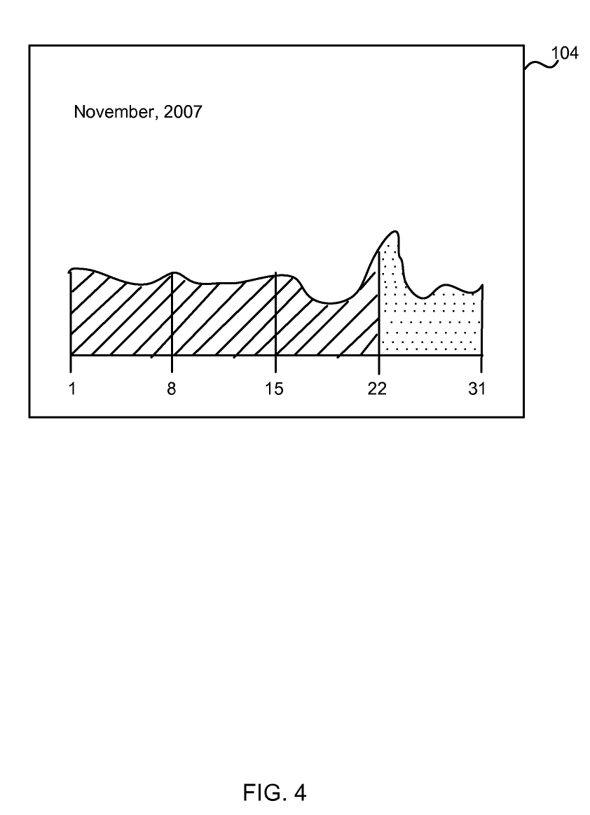

The touch sensitive display panel 104 is arranged such that touching the panel 104 causes the display to ‘zoom in’, i.e. show the region of the display associated with that time period in greater detail. In this embodiment, the microprocessor 202 is arranged to identify the month associated with the region of display panel 104. This results in the microprocessor 202 using the display driver 208 to control the display panel 104 to display a record of the data collected in that month, as is shown in FIG. 4, which takes the exemplary month of November 2007.

In the month-level data shown in FIG. 4, the data is smoothed over a shorter period, for example over a 4 hour period, so more variation can been seen. Further, each week has a distinct visual appearance according to whether the data in that week was mostly ‘conversation’, ‘music/TV’ or ‘background noise’, i.e. according to its determined category. In the first three weeks of the month, the sound was mostly categorized as ‘conversation’ but in the last full week, the sound was mostly ‘Music/TV’. The exemplary embodiment shows a peak around the 23^{rd} November, which demonstrates that there was a loud volume event, such as a party, on that day.

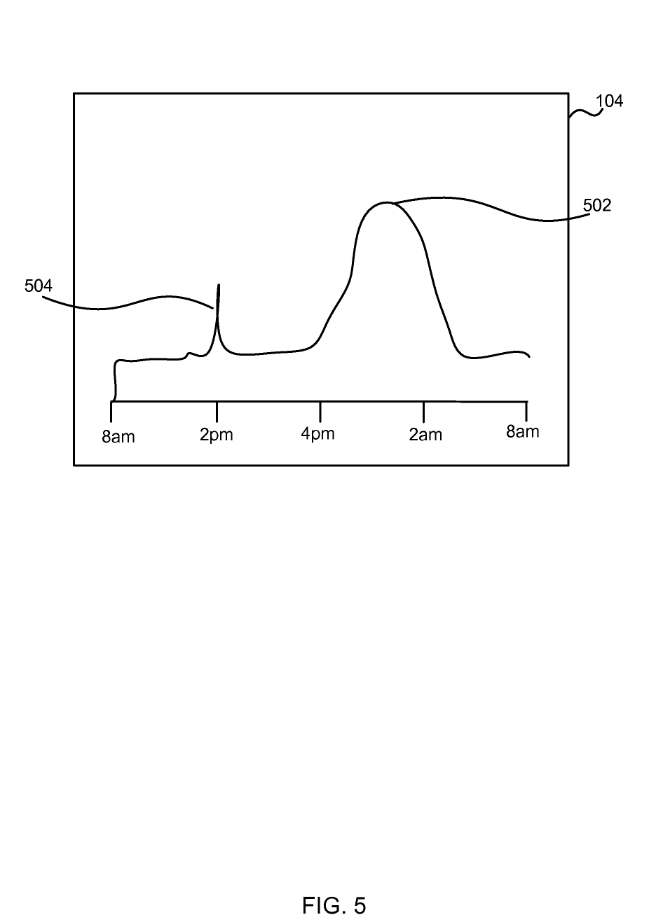

The user may then opt to zoom in further by touching the display panel 104 again. This results in the display changing to show one day's data in further detail, as is shown in FIG. 5.

FIG. 5 shows the data from 23^{rd} November, which it can be seen comprises a peak 502 around 10 pm, suggesting a loud evening event such as a party, and a short duration peak 504 at around 2 pm, suggesting a brief loud noise such as a door slamming. A brief event such as a door slamming can now be seen as the data is no longer smoothed as it was for the month and year views of FIGS. 1 and 4. The user can further interact with the display panel 104. If a user touches the panel 104, a sample of sound from the time associated with that area of the panel 104 will be retrieved from the memory 204 by the microprocessor 202 and played back to the user through the microphone/speaker 106. Thus, if a user touches the panel 104 in the region of the peak 502, he or she will hear a portion of sound recorded during the party.

In this example, if the display panel 104 is not touched for ten minutes, the panel 104 reverts to displaying data year by year, as is shown in FIG. 1.

It will be appreciated that there are a number of variations which could be made to the above described exemplary embodiment without departing from the scope of the invention. For example, the display panel 104 may not be a touch sensitive display panel. The device 100 could comprise another input means such as buttons, a keyboard, a mouse, a remote control, other remote input means, or the like. Alternatively, the touch sensitive display panel 104 could be provided and operate using alternative known technology to that described above. The microprocessor 202 may be arranged to process the sound using an algorithm such that a muffled ‘abstraction’ is stored rather than the sound itself. The term ‘abstraction’ as used in this context should be understood in its sense of generalization by limiting the information content of the audio environment, leaving only the level of information required for a particular purpose. The device 100 may not continually store sound, but instead store a sample of the sound from each predetermined period of time, such as 10 minutes in each hour. In some embodiments, the user may be able to select when sound is stored. The device 100 may include an input means allowing the user to choose when sound should be recorded and/or else when no sound should be recorded. The user may be able to select whether sound is stored as an abstraction or as received using another input means. In the above embodiment, these input means may be provided by dedicated areas of the display panel 104. This allows the user to control the level of privacy.

The above example generally displays data year-by-year, but in other embodiments, the display may generally show week-by-week or month-by-month or day-by-day data. The display may vary over time; for example in one embodiment, the device 100 may be arranged to display data day-by-day until two weeks' data has been collected, then week-by-week until two months' data has been collected, then month by month until a year's data has been collected.

The device 100 can be used both nostalgically, to remind a user of an event, and forensically, for example to determine an event that occurred in the user's absence. For example, the device 100 would reflect if a party had been held while a home owner was on holiday.

In some embodiments, a microphone may be remote from the display device 100. In such embodiments, the display device 100 will provide a remote indication of the level of audio activity in the location of the microphone. Such an embodiment could be used to monitor an environment remotely (such as monitoring one's home environment when on holiday or at one's place of business) or to connect remote environments so as to provide a feeling of connection to the events local to the microphone.

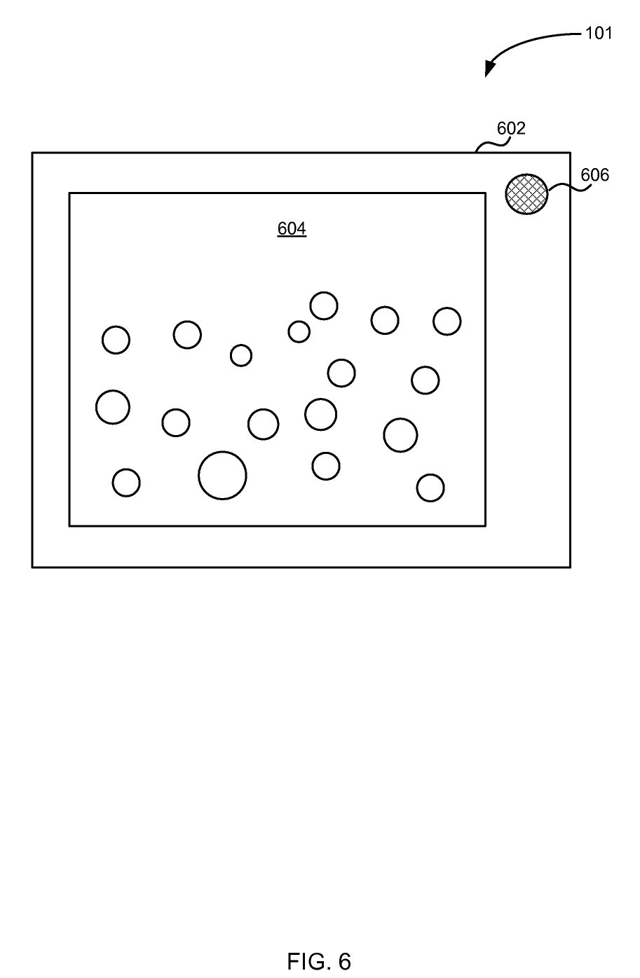

A second embodiment of a sound display device 101 is now described with reference to FIG. 6. In this embodiment, the device 101 is arranged to display a representation of the instant sound quality in a room.

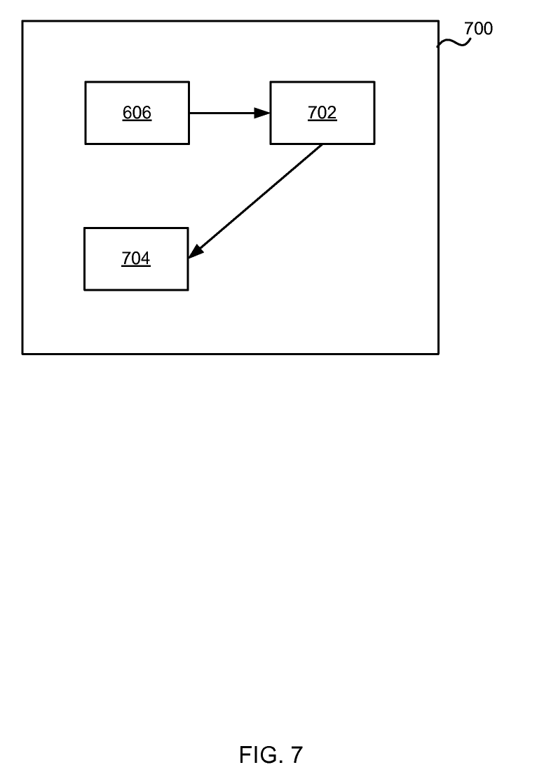

In this embodiment, the display device 101 comprises a housing 602 for a display screen 604 arranged to show an animation of a boiling liquid. The device 101 further comprises a microphone 606 and processing circuitry 700 described in greater detail with reference to FIG. 7.

The processing circuitry 700 comprises a microprocessor 702 which is arranged to receive inputs from the microphone 606 and is arranged to control a display driver 704 (which in turn controls the display screen 604) according to the microprocessor's 702 analysis of the sound received by the microphone 606.

As is described with reference to the flow chart of FIG. 7, in use of the device 101, the microphone 606 receives the ambient sound (block 802). This is analyzed by the microprocessor 702 to determine its volume (block 804). The microprocessor then controls the display screen 604 via the display driver 704 to change the display (block 806). In this embodiment, the louder the sound, the more bubbles are displayed on the display screen 604, and the quicker they move. The bubbles therefore provide an animation of simmering to briskly boiling liquid depending on the volume. These creates an analogy between the volume in the room and the ‘temperature’ of the liquid. More generally, the volume of in the room is translated into the ‘energy’ within the animation.

In alternative embodiments, the display may not be of a boiling liquid but could instead show other activities that may increase in speed and/or magnitude with volume, such as waves, moving figures, pulsing shapes or the like. Alternatively or additionally, the color of the display could change with volume. In other embodiments, qualities of the sound other than (or in conjunction with) its volume may be used to trigger a change of the display. For example, the display device could incorporate a sound recognition means capable of determining the source of sound, for example by comparing characteristics of the sound with predetermined values. This would allow the display to reflect the source of the sound—for example, music may cause a bubble display whereas conversation could cause the display to show a wave formation.

In one embodiment, the display means could be interactive wall paper. Such embodiments could use light projections to provide controllable wallpaper, or use electronic paper such as paper printed with electronic ink. As will be familiar to the person skilled in the art, electronic ink changes color in response to an applied electronic current.

FIGS. 1, 2, 6 and 7 illustrate various components of exemplary computing-based devices which may be implemented as any form of a computing and/or electronic device, and in which any of the above described embodiments of may be implemented.

The computing-based devices may comprise one or more inputs which are of any suitable type for receiving media content, Internet Protocol (IP) input and may comprise communication interfaces.

The computing-based devices also comprises processing circuitry which includes microprocessors, but could alternatively include controllers or any other suitable type of processors for processing computing executable instructions to control the operation of the device in the manner set out herein.

Computer executable instructions may be provided using any computer-readable media, such as memory. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output is also provided such as an audio and/or video output to a display system integral with or in communication with the computing-based device. The display system may provide a graphical user interface, or other user interface of any suitable type although this is not essential.

The terms ‘processing circuitry’ and ‘microprocessor’ are used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of preferred embodiments is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, features from one embodiment could be combined with those of another embodiment.

1. Method of displaying at least one characteristic of sound comprising
(i) receiving sound over a period of time
(ii) analyzing the sound to determine at least one characteristic of the sound
(iii) cumulatively displaying at least one determined sound characteristic on a display device over the period of time.

2. A method according to claim 1 in which the step of displaying the at least one determined sound characteristic includes displaying the time at which the sound was received.

3. A method according to claim 1 which further comprises storing at least a portion of the sound received.

4. A method according to claim 3 which further comprise the step of playing back stored sound.

5. A method according to claim 1 which further comprises the step of accepting a user input to the display device and using the input to select the time period for which the at least one determined sound characteristic is displayed.

6. A method according to claim 1 in which the step of cumulatively displaying the at least one determined sound characteristic comprises displaying the at least one determined sound characteristic in visually distinct layers, wherein each layer represents a predetermined time period.

7. A method according to claim 6 in which the characteristic of the sound is used to determine at least one of the height or appearance of the layer.

8. A method according to claim 1 in which in which the step of cumulatively displaying the at least one determined sound characteristic comprises smoothing the data received over a predetermined time period.

9. A method according to claim 1 in which the step of receiving sound is carried out remotely from the step of cumulatively displaying the at least one determined sound characteristic and the method further comprises transmitting the sound and/or the at least one determined sound characteristic from the location in which the sound is received to the display device.

10. A method according to claim 1 in which the step of analyzing the sound to determine at least one characteristic of the sound comprises determining one of the following: the volume of the sound, the source of sound.

11. A sound display device comprising a microphone arranged to receive sound, processing circuitry arranged to analyze sound and to determine at least one characteristic thereof, and a display arranged to display the at least one characteristic such that alterations in the at least one characteristic can be readily perceived by a user of the display device.

12. A sound display device according to claim 11 which further comprises a memory arranged to store sound in association with the time at which the sound was received and a speaker arranged to allow the play back of sound, wherein the display device is arranged to display the at least one characteristic over time and a user is able to select a time period from which sound is played back.

13. A sound display device according to claim 12 which further comprises an input means arranged to allow a user to specify when sound is stored in the memory.

14. A sound display device according to claim 12 in which the processing circuitry is arranged to store an abstraction of the sound received by the microphone and is arranged to play back the stored abstraction of the sound received.

15. A sound display device according to claim 14 which further comprises an input means arranged to allow a user to specify when an abstraction of the sound is stored.

16. A sound display device according to claim 11 in which the display is a touch sensitive display.

17. A sound display device according to claim 11 in which the display is a wall mounted display.

18. Method of displaying changes in at least one characteristic of sound comprising:
(i) monitoring the ambient sound in an environment;
(ii) analyzing the sound to determine at least one characteristic of the sound;
(iii) reflecting at least one determined sound characteristic in a moving element of a visual display;
(iv) reflecting any change in the at least one determined sound characteristic by a change in activity of the moving element.

19. A method according to claim 18 in which the visual display is an animation.

20. A method according to claim 18 in which the moving element comprises a plurality of moving objects.
